(19) United States
(12) Patent Application Publication
(10) Pub. No.: US 2015/0359311 A1
(43) Pub. Date: Dec. 17, 2015

(54) Lotion Applicator Device

(71) Applicant: Abeke Akinyinka, Houston, TX (US)

(72) Inventor: Abeke Akinyinka, Houston, TX (US)

(21) Appl. No.: 14/303,719

(22) Filed: Jun. 13, 2014

(51) Int. Cl. A45D 34/04; A61H 7/00

(52) U.S. Cl. CPC A45D 34/04; A61H 7/005

(57) ABSTRACT

A lotion applicator device allows a person to more easily scratch, massage and apply lotion onto hard-to-reach areas of the person's body. The device includes a handle having a first end, a second end and a perimeter wall coupled to and extending between the first end and the second end. A first attachment unit is attached to the first end of the handle. The first attachment unit includes a scratching implement. The scratching implement includes a plurality of prongs wherein the scratching implement is configured for scratching the person's body. A second attachment unit is attached to the second end of the handle. The second attachment unit includes an absorbent member. The absorbent member is configured to receive a fluid to be applied to a person's body.

### BACKGROUND OF THE DISCLOSURE

### Field of the Disclosure

The disclosure relates to lotion application assemblies and more particularly pertains to a new lotion application assembly for allowing a person to more easily scratch, massage and apply lotion onto hard-to-reach areas of the person's body.

### SUMMARY OF THE DISCLOSURE

An embodiment of the disclosure meets the needs presented above by generally comprising a handle having a first end, a second end and a perimeter wall coupled to and extending between the first end and the second end. A first attachment unit is attached to the first end of the handle. The first attachment unit includes a scratching implement. The scratching implement includes a plurality of prongs wherein the scratching implement is configured for scratching the person's body. A second attachment unit is attached to the second end of the handle. The second attachment unit includes an absorbent member. The absorbent member is configured to receive a fluid to be applied to a person's body.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a lotion applicator device according to an embodiment of the disclosure.

FIG. 2 is a bottom perspective view of an embodiment of the disclosure.

FIG. 3 is a top view of an embodiment of the disclosure.

FIG. 4 is a side view of an embodiment of the disclosure.

FIG. 5 is a detailed top view of an embodiment of the disclosure showing how the scratching implement can be inserted into the slot.

### DESCRIPTION OF THE PREFERRED EMBODIMENT

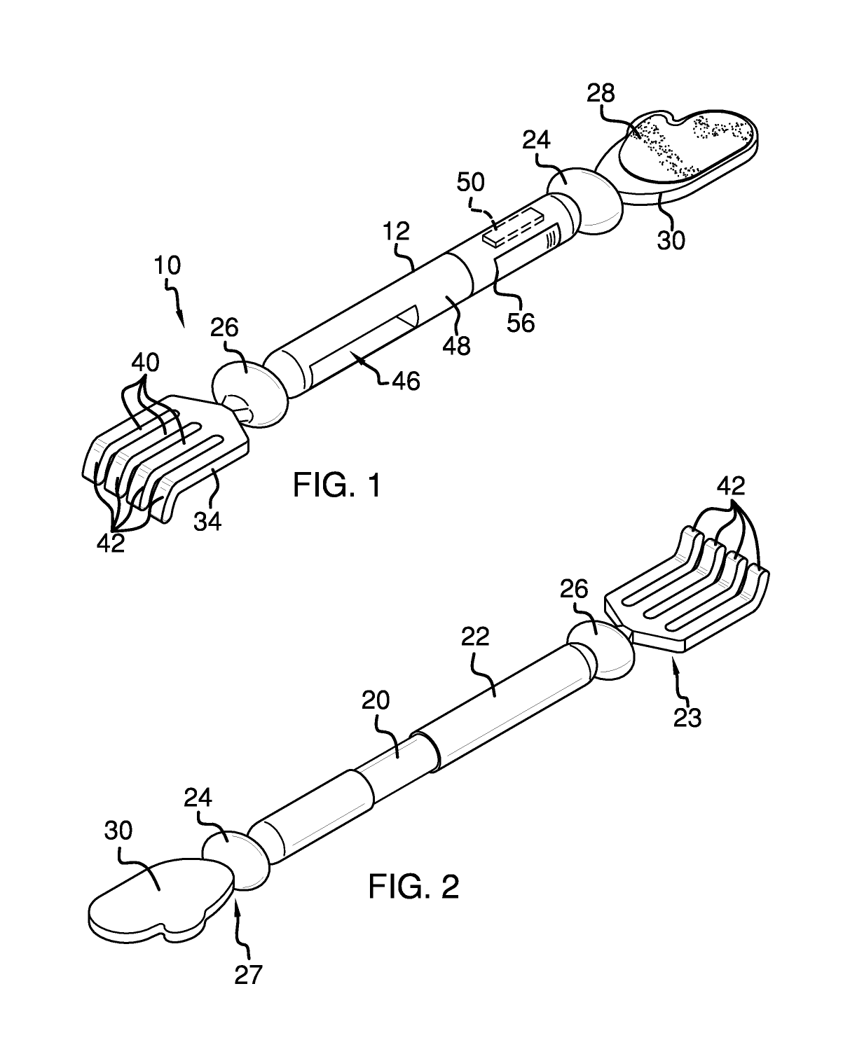

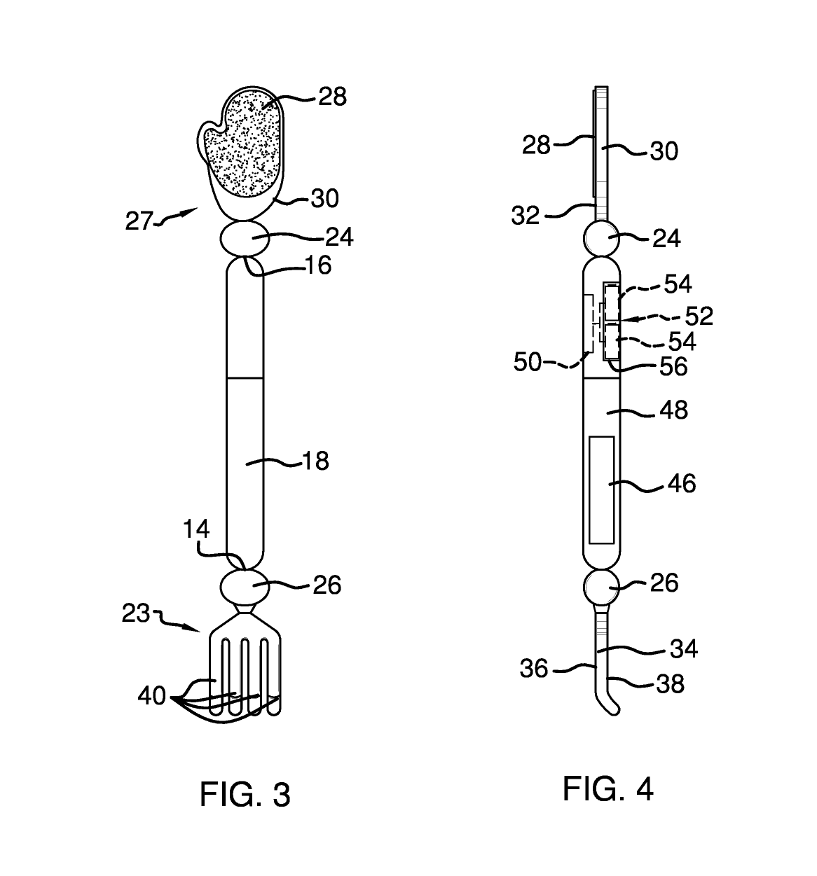

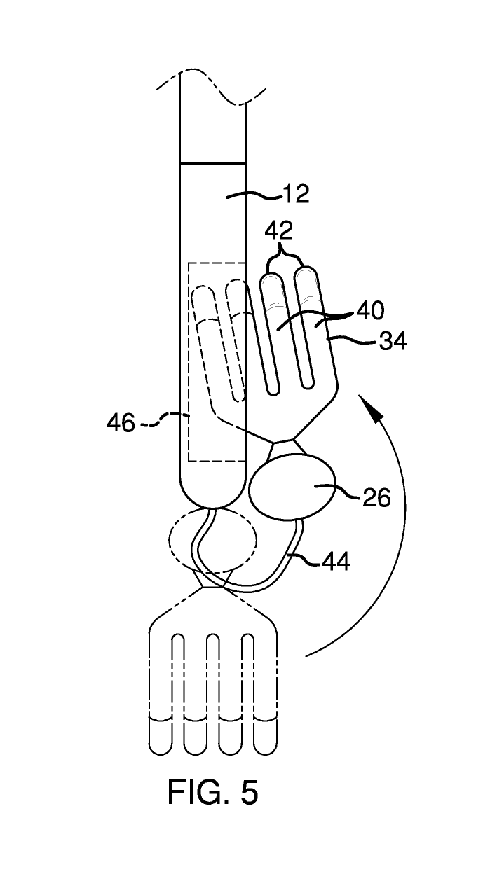

With reference now to the drawings, and in particular to FIGS. 1 through 5 thereof, a new lotion application assembly embodying the principles and concepts of an embodiment of the disclosure and generally designated by the reference numeral 10 will be described.

As best illustrated in FIGS. 1 through 5, the lotion applicator device 10 generally comprises a handle 12 having a first end 14, a second end 16 and a perimeter wall 18 coupled to and extending between the first end 14 and the second end 16. The handle 12 has a longitudinal axis extending through the first 14 and second 16 ends. The handle 12 may be telescopic in a generally conventional manner. For example, the handle 12 may include an extension rod member 20 being slidably insertable into an outer sleeve member 22 of the handle 12.

A first attachment unit 23 is attached to the first end 14 of the handle. The first attachment unit 23 includes a base 26 and a scratching implement 34. The base 26 of the first attachment unit 23 is positioned between the handle 12 and the scratching implement 34. The scratching implement 34 has an upper surface 36 and a lower surface 38 that may each be planar. The scratching implement 34 includes a plurality of prongs 40 wherein the scratching implement 34 is configured for scratching the person's body. Each of the prongs 40 has an outer end 42 positioned distally with respect to the handle 12. The outer ends 42 of each of the prongs 40 may curve downwardly and away with respect to the upper surface 36. Each of the prongs 40 may be spaced from an adjacently positioned one of the prongs 40.

A second attachment unit 27 is attached to the second end 16 of the handle 12. The second attachment unit 27 includes a base 24, an absorbent member 28 and a plate 30. The base 24 of the second attachment unit 27 is positioned between the handle 12 and the plate 30. The absorbent member 28 is configured to receive a fluid to be applied to a person's body. The fluid may include lotion, massage oil or the like. The absorbent member 28 is positioned on a top surface 32 of the plate. The plate 30 may be orientated in a plane parallel to the longitudinal axis of the handle 12.

The first attachment unit 23 is extendable from the first end 14 of the handle 12. This may be accomplished in a number of different ways and the exact means for providing this functionality is not critical. For example, a tether 44 may be provided that couples the first attachment unit 23 to the first end 14 of the handle 12. Alternatively, an elasticized band may be used to attach the first attachment unit 23 to the first end 14 of the handle. An associated lateral side 48 of the perimeter wall 18 of the handle 12 has an elongated slot 46 extending therein. At least some of the prongs 40 are insertable into the slot 46 to store the scratching implement 34 in the slot 46.

A vibration unit 50 is coupled to the handle 12. The vibration unit 50 is configured to cause the device 10 to vibrate so that the device 10 permits a person to massage his or her own body. A power source 52 is coupled to the handle 12. The power source 52 is electrically coupled to the vibration unit 50 for providing electrical power to the vibration unit 50. The power source 52 may comprise at least one rechargeable battery 54 positioned in a compartment 56 of the handle 12.

In use, as stated above and shown in the Figures, the device 10 is used to apply fluids onto hard-to-reach areas of the user's body, to massage the user's body and/or to scratch the user's body. In particular, the fluid is applied onto the absorbent member 28 and rubbed against the user's body to facilitate application of the fluid onto the user's body; the vibration unit 50 is activated to cause the entire device 10 to vibrate and function as a massager; and the prongs 40 of the scratching implement 34 are scratched against the user's body as desired.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A lotion applicator device comprising:
a handle having a first end, a second end and a perimeter wall coupled to and extending between said first end and said second end;
a first attachment unit being attached to said first end of said handle, said first attachment unit including a scratching implement, said scratching implement including a plurality of prongs wherein said scratching implement is configured for scratching the person's body; and
a second attachment unit attached to said second end of said handle, said second attachment unit including an absorbent member, said absorbent member being configured to receive a fluid to be applied to a person's body.

2. The device of claim 1, further comprising:
said handle having a longitudinal axis extending through said first and second ends; and
said second attachment unit including a plate, said absorbent member being positioned on a top surface of said plate, said plate being orientated in a plane parallel to said longitudinal axis of said handle.

3. The device of claim 1, further comprising said handle being telescopic.

4. The device of claim 1, further comprising:
said scratching implement having an upper surface and a lower surface; and
each of said prongs having an outer end positioned distally with respect to said handle, said outer ends of each of said prongs curving downwardly and away with respect to said upper surface.

5. The device of claim 1, further comprising said scratching implement being extendable from said first end of said handle.

6. The device of claim 5, further comprising a tether coupling said scratching implement to said first end of said handle.

7. The device of claim 5, further comprising an associated lateral side of said perimeter wall of said handle having an elongated slot extending therein, at least some of said said prongs being insertable into said slot to store said scratching implement within said slot.

8. The device of claim 1, further comprising each of said prongs being spaced from an adjacently positioned one of said prongs.

9. The device of claim 1, further comprising a vibration unit coupled to said handle, said vibration unit being configured to cause said device to vibrate.

10. The device of claim 1, further comprising a power source coupled to said handle, said power source being electrically coupled to said vibration unit for providing electrical power to said vibration unit.

11. The device of claim 1, further comprising said scratching implement having an upper surface and a lower surface each being planar.

12. A lotion applicator device comprising:
a handle having a first end, a second end and a perimeter wall coupled to and extending between said first end and said second end, said handle having a longitudinal axis extending through said first and second ends, said handle being telescopic, an associated lateral side of said perimeter wall of said handle having an elongated slot extending therein;
a first attachment unit being attached to said first end of said handle, said first attachment unit including a scratching implement, said scratching implement having an upper surface and a lower surface each being planar, said scratching implement including a plurality of prongs wherein said scratching implement is configured for scratching the person's body, each of said prongs having an outer end positioned distally with respect to said handle, said outer ends of each of said prongs curving downwardly and away with respect to said upper surface, each of said prongs being spaced from an adjacently positioned one of said prongs, said scratching implement being extendable from said first end of said handle, at least some of said said prongs being insertable into said slot to store said scratching implement within said slot;
a second attachment unit attached to said second end of said handle, said second attachment unit including an absorbent member and a plate, said absorbent member being configured to receive a fluid to be applied to a person's body, said plate being orientated in a plane parallel to said longitudinal axis of said handle, said absorbent member being positioned on a top surface of said plate;
a tether coupling said scratching implement to said first end of said handle; and
a vibration unit coupled to said handle, said vibration unit being configured to cause said device to vibrate, a power source coupled to said handle, said power source being electrically coupled to said vibration unit for providing electrical power to said vibration unit.
